(19) United States
(12) Patent Application Publication
(10) Pub. No.: US 2013/0249337 A1
(43) Pub. Date: Sep. 26, 2013

(54) HYDRODYNAMIC BEARING MODULE AND SPINDLE MOTOR HAVING THE SAME

(71) Applicant: SAMSUNG ELECTRO-MECHANICS CO., LTD., Suwon (KR)

(72) Inventors: Yong Sik Kim, Suwon (KR); Il Oung Park, Suwon (KR); Ho Kyung Jang, Suwon (KR)

(73) Assignee: SAMSUNG ELECTRO-MECHANICS CO., LTD., Suwon (KR)

(21) Appl. No.: 13/848,434

(22) Filed: Mar. 21, 2013

(30) Foreign Application Priority Data
Mar. 22, 2012 (KR) 10-2012-0029350

(51) Int. Cl. F16C 32/06; H02K 7/08

(52) U.S. Cl. CPC F16C 32/0629; H02K 7/08
USPC 310/90; 384/114

(57) ABSTRACT

Disclosed herein is a hydrodynamic bearing module, including: a shaft; a sleeve having the shaft rotatably and insertedly coupled thereinto and forming a micro-interval together with the shaft; oil injected in order to form a hydrodynamic bearing part between the shaft and the sleeve; a cover coupled to a lower end portion of the sleeve and sealing the oil; and a protrusion member positioned between the shaft and the cover in an axial direction of the shaft and selectively mounted on the cover or the shaft.

### CROSS REFERENCE TO RELATED APPLICATION

This application claims the benefit of Korean Patent Application No. 10-2012-0029350, filed on Mar. 22, 2013, entitled “Hydrodynamic Bearing Module and Spindle Motor Having the Same”, which is hereby incorporated by reference in its entirety into this application.

### BACKGROUND OF THE INVENTION

1. Technical Field

The present invention relates to a hydrodynamic bearing module and a spindle motor having the same.

2. Description of the Related Art

Generally, in a spindle motor used as a driving device of a recording disk such as a hard disk, or the like, a hydrodynamic bearing using dynamic pressure generated by a lubricating fluid such as oil, or the like, stored between a rotor part and a stator part at the time of rotation of the motor has been widely used.

More specifically, since the spindle motor including the hydrodynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk device, a magnetic disk device, or the like.

The following Prior Art Document (Patent Document) relates to a spindle motor having a hydrodynamic bearing. However, in the spindle motor according to the prior art including the prior art document, when a hub is press-fitted into a shaft, a cover is deformed as much as a distance between the cover and the shaft, such that a coupling part such as a welding part or the like may be damaged, or a micro-crack, leakage of oil, or the like may occur.

### PRIOR ART DOCUMENT

### Patent Document

(Patent Document 1) U.S. Pat. No. 6,534,890 B

### SUMMARY OF THE INVENTION

The present invention has been made in an effort to provide a hydrodynamic bearing module capable of preventing leakage of oil by decreasing an interval between a shaft and a cover by a thickness of a protrusion member to thereby decrease volume change at the time of movement of the shaft in an axial direction according to external impact and preventing a micro-crack and oil leakage caused by deformation of the center part by a coupling part of the cover and a sleeve since the center part of the cover facing the shaft is deformed by the interval between the shaft and the cover and the deformed displacement is decreased by the thickness of the protrusion member in the case in which the shaft is press-fitted into a hub due to an outer peripheral surface of the cover which is secured to the sleeve, and a spindle motor having the same.

According to a preferred embodiment of the present invention, there is provided a hydrodynamic bearing module, including: a shaft; a sleeve having the shaft rotatably and insertedly coupled thereinto and forming a micro-interval together with the shaft; oil injected in order to form a hydrodynamic bearing part between the shaft and the sleeve; a cover coupled to a lower end portion of the sleeve and sealing the oil; and a protrusion member positioned between the shaft and the cover in an axial direction of the shaft and selectively mounted on the cover or the shaft.

The protrusion member may be coupled to a lower end portion of the shaft so as to face the cover.

The protrusion member may be coupled to one surface of the cover so as to face the shaft.

According to another preferred embodiment of the present invention, there is provided a hydrodynamic bearing module, including: a shaft; a sleeve having the shaft rotatably and insertedly coupled thereinto and forming a micro-interval together with the shaft; oil injected in order to form a hydrodynamic bearing part between the shaft and the sleeve; and a cover coupled to a lower end portion of the sleeve and sealing the oil, wherein the cover may face the shaft in an axial direction of the shaft so as to form a protrusion part.

The protrusion part may be formed by press processing of the cover.

According to another preferred embodiment of the present invention, there is provided a spindle motor, including: a rotor including a shaft, a hub, and a magnet; a stator including a sleeve rotatably supporting the shaft, a base having the sleeve coupled thereto, an armature coupled to the base so as to face the magnet, and a cover coupled to a lower portion of the sleeve; a hydrodynamic bearing part formed between the rotor and the stator by being filled with oil, which is working fluid; and a protrusion member positioned between the shaft and the cover in an axial direction of the shaft and selectively mounted on the cover or the shaft.

The protrusion member may be coupled to a lower end portion of the shaft so as to face the cover.

The protrusion member may be coupled to one surface of the cover so as to face the shaft.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a partial cross-sectional view schematically showing a hydrodynamic bearing module according to a first preferred embodiment of the present invention;

FIG. 2 is a partial cross-sectional view schematically showing a hydrodynamic bearing module according to a second preferred embodiment of the present invention;

FIG. 3 is a partial cross-sectional view schematically showing a hydrodynamic bearing module according to a third preferred embodiment of the present invention; and

FIG. 4 is a cross-sectional view schematically showing a spindle motor having the hydrodynamic bearing module according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

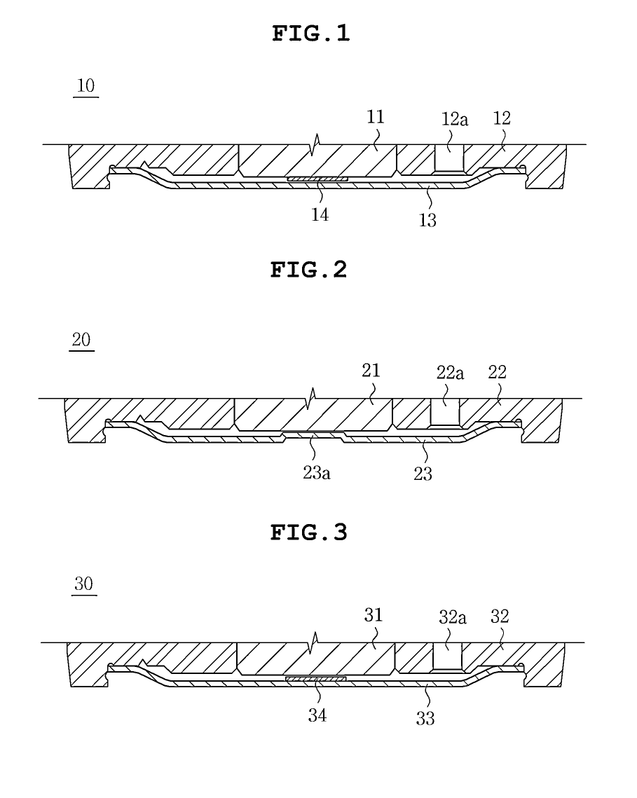

FIG. 1 is a partial cross-sectional view schematically showing a hydrodynamic bearing module according to a first preferred embodiment of the present invention. As shown in FIG. 1, the hydrodynamic bearing module 10 includes a shaft 11, a sleeve 12, a cover 13, and a protrusion member 14, wherein the protrusion member 14 is coupled to a lower end portion of the shaft 11 facing the cover in an axial direction of the shaft.

More specifically, the shaft 11 is insertedly coupled to the sleeve 12 so as to form a micro-interval between the shaft 11 and the sleeve 12, and the sleeve 12 rotatably supports the shaft 11. In addition, oil is injected into the micro-interval, such that a radial bearing part (not shown) which is a hydrodynamic bearing part is formed. Further, the radial bearing part may be formed on upper and lower portions of the sleeve.

In addition, an oil circulation hole 12a connecting upper and lower surfaces of the sleeve 12 to each other in order to circulate the oil which is injected to form the hydrodynamic bearing part in a shaft system may be formed in the axial direction of the shaft 11.

In addition, the cover 13, which is to seal the oil injected in order to form the hydrodynamic bearing part between the shaft and the sleeve, is coupled onto an inner peripheral surface of a lower end portion of the sleeve 12 in the axial direction of the shaft 11. In addition, the cover and the sleeve may be coupled to each other by a method such as welding, bonding, or the like.

In addition, the protrusion member 14 is coupled to the lower end portion of the shaft 11 facing the cover 13 in the axial direction of the shaft as described above.

According to the configuration as described above, an interval between the shaft 11 and the cover 13 is decreased by a thickness of the protrusion member 14. This may prevent leakage of oil by decreasing volume change at the time of movement of the shaft in an axial direction according to external impact.

In addition, since an outer peripheral surface of the cover is secured to the sleeve, in the case in which the shaft is press-fitted into a hub, the center part of the cover facing the shaft is deformed by an interval between the shaft and the cover and the deformed displacement is decreased by the thickness of the protrusion member 14, such that a coupling part of the cover and the sleeve may prevent a micro-crack and oil leakage caused by deformation of the center part.

FIG. 2 is a partial cross-sectional view schematically showing a hydrodynamic bearing module according to a second preferred embodiment of the present invention.

As shown in FIG. 2, the hydrodynamic bearing module 20 according to the second preferred embodiment of the present invention is different only in a cover from the hydrodynamic bearing module 10 according to the first preferred embodiment of the present invention. That is, the hydrodynamic bearing module according to the second preferred embodiment of the present invention deforms a shape of the cover so as not to include a separate protrusion member.

More specifically, the hydrodynamic bearing module 20 includes a shaft 21, a sleeve 22, and a cover 23, wherein the cover 23 faces the shaft 21 in the axial direction of the shaft so as to form a protrusion part 23a. In addition, the protrusion part 23a may be easily formed by press processing.

In addition, the shaft 21 is insertedly coupled to the sleeve 22 so as to form a micro-interval between the shaft 21 and the sleeve 22, and the sleeve 22 rotatably supports the shaft 21. In addition, oil is injected into the micro-interval, such that a radial bearing part (not shown) which is a hydrodynamic bearing part is formed. Further, the radial bearing part may be formed on upper and lower portions of the sleeve.

In addition, an oil circulation hole 22a connecting upper and lower surfaces of the sleeve 22 to each other in order to circulate the oil which is injected to form the hydrodynamic bearing in a shaft system may be formed in the axial direction of the shaft 21.

In addition, the cover 23, which is to seal the oil injected in order to form the hydrodynamic bearing part between the shaft 21 and the sleeve 22, is coupled onto an inner peripheral surface of a lower end portion of the sleeve 22 in the axial direction of the shaft 21. In addition, the cover and the sleeve may be coupled to each other by a method such as welding, bonding, or the like.

According to the configuration as described above, an interval between the shaft 21 and the cover 23 is decreased by a thickness of the protrusion part 23a. This may prevent leakage of oil by decreasing volume change at the time of movement of the shaft in an axial direction according to external impact, and since an outer peripheral surface of the cover is secured to the sleeve, in the case in which the shaft is press-fitted into a hub, the center part of the cover facing the shaft is deformed by an interval between the shaft and the cover and the deformed displacement is decreased by the protrusion part 23a, such that a coupling part of the cover and the sleeve may prevent a micro-crack and oil leakage caused by deformation of the center part.

FIG. 3 is a partial cross-sectional view schematically showing a hydrodynamic bearing module according to a third preferred embodiment of the present invention.

As shown in FIG. 3, the hydrodynamic bearing module 30 according to the third preferred embodiment of the present invention is different only in a coupling target of the protrusion member from the hydrodynamic bearing module 10 according to the first preferred embodiment of the present invention. That is, the hydrodynamic bearing module 30 according to the third preferred embodiment of the present invention couples the protrusion member to the cover.

More specifically, the hydrodynamic bearing module 30 includes a shaft 31, a sleeve 32, a cover 33, and a protrusion member 34, wherein the protrusion member 34 is coupled to a lower end portion of the shaft 31 facing the cover in an axial direction of the shaft.

More specifically, the shaft 31 is insertedly coupled to the sleeve 32 so as to form a micro-interval between the shaft 31 and the sleeve 32, and the sleeve 32 rotatably supports the shaft 31. In addition, oil is injected into the micro-interval, such that a radial bearing part (not shown) which is a hydrodynamic bearing part is formed. Further, the radial bearing part may be formed on upper and lower portions of the sleeve.

In addition, an oil circulation hole 32a connecting upper and lower surfaces of the sleeve 32 to each other in order to circulate the oil which is injected to form the hydrodynamic bearing part in a shaft system may be formed in the axial direction of the shaft 31.

In addition, the cover 33, which is to seal the oil injected in order to form the hydrodynamic bearing part between the shaft and the sleeve, is coupled onto an inner peripheral surface of a lower end portion of the sleeve 32 in the axial direction of the shaft 31. In addition, the cover and the sleeve may be coupled to each other by a method such as welding, bonding, or the like.

In addition, the protrusion member 34 is coupled to one surface of the cover 33 facing the shaft 31 in the axial direction of the shaft as described above.

According to the configuration as described above, an interval between the shaft 31 and the cover 33 is decreased by a thickness of the protrusion member 34. This may prevent leakage of oil by decreasing volume change at the time of movement of the shaft in an axial direction according to external impact.

In addition, since an outer peripheral surface of the cover 33 is secured to the sleeve, in the case in which the shaft is press-fitted into a hub, the center part of the cover facing the shaft is deformed by an interval between the shaft and the cover and the deformed displacement is decreased by the thickness of the protrusion member 34, such that a coupling part of the cover and the sleeve may prevent a micro-crack and oil leakage caused by deformation of the center part.

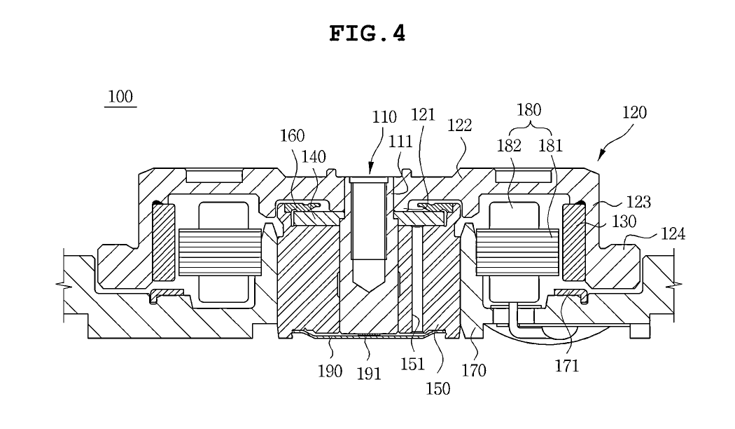

FIG. 4 is a cross-sectional view schematically showing a spindle motor having the hydrodynamic bearing module according to a preferred embodiment of the present invention.

As shown in FIG. 4, the spindle motor 100 is configured to include a rotor including a shaft 110, a hub 120, a magnet 130, and a thrust plate 140; a stator including a sleeve 150, a sealing member 160, a base 170, an armature 180, and a cover; and a hydrodynamic bearing part formed between the rotor and the stator by being filled with oil, which is working fluid.

More specifically, in the rotor, the shaft 110 includes the hub 120 fixedly coupled to an outer peripheral portion thereof.

In addition, the hub 120 includes a cylindrical part 121 fixed to the shaft 110, a disk part 122 extended from the cylindrical part 121 in an outer diameter direction, a sidewall part 123 extended downwardly from an end portion of the disk part 122 in the outer diameter direction in an axial direction of the shaft, and a disk mounting part 124 extended from the sidewall part 123 in the outer diameter direction.

In addition, the shaft 110 includes the thrust plate 140 coupled to an upper portion thereof and the thrust plate 140 is mounted on the outer peripheral portion so as to be positioned at a lower portion of the hub in the axial direction of the shaft.

In addition, the sidewall part 123 includes an annular ring shaped magnet 130 mounted on an inner peripheral surface thereof so as to face the armature 180 including a core 181 and a coil 182.

In addition, the disk mounting part 124, which is formed in a circumferential direction of the hub, is mounted with a disk (not shown).

In addition, an outer peripheral surface of the shaft 110 is mounted with the thrust plate 140 positioned below the cylindrical part 121 of the hub 120 and facing an upper surface of the sleeve. The thrust plate 140 may be provided with a thrust dynamic pressure generation groove (not shown) for forming the thrust dynamic pressure bearing together with the sleeve 150.

Next, in the stator, the sleeve 150 rotatably supports the shaft 110. In addition, an upper portion of the sleeve 150 is coupled to the sealing member 160 for forming an oil sealing part together with the thrust plate 140.

In addition, a dynamic pressure generation groove (not shown) is selectively formed at upper and lower portions of an inner peripheral surface of the sleeve 150 or upper and lower portions of an outer peripheral surface of the shaft 110 in order to form the radial bearing part.

Further, the sleeve 150 may have an oil circulation hole 142 formed therein in the axial direction of the shaft 110 so that upper and lower surfaces of the sleeve 150 are connected to each other in order to circulate the oil injected for forming the hydrodynamic bearing part in the shaft system.

In addition, the sleeve 150 is fixed to an inner peripheral surface of the base 170 by press-fitting, adhesion, or the like. In addition, the base 170 includes the armature 180 fixed to an outer peripheral portion thereof by press-fitting, adhesion, or the like, so as to face the magnet 130, wherein the armature 180 includes the core 181 and the coil 182.

Further, the base 170 is mounted with a pulling plate 171 so as to face the magnet 130 in the axial direction of the shaft, wherein the pulling plate 171 prevents floating of the rotor by attractive force of the magnet 130.

Further, the cover 190 is coupled to an inner peripheral surface of a lower portion of the sleeve 150 so as to seal the oil injected in order to form the hydrodynamic bearing. In addition, a protrusion member 191 is coupled to one surface of the cover 190 facing the shaft in the axial direction of the shaft.

According to the configuration as described above, the spindle motor having the hydrodynamic bearing module according to the preferred embodiment of the present invention may prevent leakage of oil by decreasing an interval between a shaft and a cover by a thickness of a protrusion member to thereby decrease volume change at the time of movement of the shaft in an axial direction according to external impact and prevent a micro-crack and oil leakage caused by deformation of the center part by a coupling part of the cover and the sleeve since the center part of the cover facing the shaft is deformed by the interval between the shaft and the cover and the deformed displacement is decreased by the thickness of the protrusion member in the case in which the shaft is press-fitted into a hub due to an outer peripheral surface of the cover which is secured to the sleeve.

In addition, the spindle motor according to the above described embodiment of the present invention has the hydrodynamic bearing module according to the third embodiment of the present invention shown in FIG. 3 and the present invention may be implemented as the spindle motor having the hydrodynamic bearing module according to the first and second embodiments.

According to the configuration as described above, the spindle motor according to the preferred embodiment of the present invention may include a fixed protrusion part that the thrust plate is inserted into a bush and the disk part facing the sleeve, improve robustness and stability by coupling to the fixed protrusion part, and form the disk part having a thin thickness. Therefore, in the spindle motor according to the present invention, a span length of the bearing may become longer than the thrust plate according to the prior art as much as the thickness decreased as compared to the spindle motor according to the prior art and stress may be distributed although the rotor is un-balanceablely rotated, thereby making it possible to implement uniform pressure distribution.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A hydrodynamic bearing module, comprising:
a shaft;
a sleeve having the shaft rotatably and insertedly coupled thereinto and forming a micro-interval together with the shaft;
oil injected in order to form a hydrodynamic bearing part between the shaft and the sleeve;
a cover coupled to a lower end portion of the sleeve and sealing the oil; and
a protrusion member positioned between the shaft and the cover in an axial direction of the shaft and selectively mounted on the cover or the shaft.

2. The hydrodynamic bearing module as set forth in claim 1, wherein the protrusion member is coupled to a lower end portion of the shaft so as to face the cover.

3. The hydrodynamic bearing module as set forth in claim 1, wherein the protrusion member is coupled to one surface of the cover so as to face the shaft.

4. A hydrodynamic bearing module, comprising:
a shaft;
a sleeve having the shaft rotatably and insertedly coupled thereinto and forming a micro-interval together with the shaft;
oil injected in order to form a hydrodynamic bearing part between the shaft and the sleeve; and
a cover coupled to a lower end portion of the sleeve and sealing the oil,
wherein the cover faces the shaft in an axial direction of the shaft so as to form a protrusion part.

5. The hydrodynamic bearing module as set forth in claim 4, wherein the protrusion part is formed by press processing of the cover.

6. A spindle motor, comprising:
a rotor including a shaft, a hub, and a magnet;
a stator including a sleeve rotatably supporting the shaft, a base having the sleeve coupled thereto, an armature coupled to the base so as to face the magnet, and a cover coupled to a lower portion of the sleeve;
a hydrodynamic bearing part formed between the rotor and the stator by being filled with oil, which is working fluid; and
a protrusion member positioned between the shaft and the cover in an axial direction of the shaft and selectively mounted on the cover or the shaft.

7. The spindle motor as set forth in claim 6, the protrusion member is coupled to a lower end portion of the shaft so as to face the cover.

8. The spindle motor as set forth in claim 6, the protrusion member is coupled to one surface of the cover so as to face the shaft.
